(19) United States
(12) Patent Application Publication
(10) Pub. No.: US 2003/0024122 A1
(43) Pub. Date: Feb. 6, 2003

(54) Method and apparatus for producing hydrodynamic bearing parts by electrochemical machining

(76) Inventors: Yoshikazu Ichiyama, Ukyo-ku (JP); Kenichi Yamazaki, Omihachiman-shi (JP); Takayuki Hachida, Kasugai-shi (JP); Takeshi Takaoka, Ukyo-ku (JP); Atsushi Morosawa, Komaki-shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/173,833

(22) Filed: Jun. 19, 2002

Related U.S. Application Data
(63) Continuation-in-part of application No. 09/629,627, filed on Jul. 31, 2000, now abandoned.

(30) Foreign Application Priority Data
Jul. 29, 1999 (JP) 11-216008
Jul. 30, 2001 (JP) 2001-230274

(51) Int. Cl. B21K 1/76; B23P 17/00

(52) U.S. Cl. 29/898

(57) ABSTRACT

The method of and apparatus for producing fluid dynamic bearing parts is provided. Sets of grooves are formed by an electrochemical machining apparatus based on a design specification. The electrochemical machining process includes a process for extracting one bearing part in every predetermined number of machining cycles during the bearing parts production, a process for measuring shapes of the grooves on the extracted bearing part, a process for comparing the shapes of the grooves on the extracted bearing part with the design specification data, and a process for changing settings of the electrochemical machining apparatus depending on the result of the comparison. With these processes a stable and precise production of grooves on the fluid dynamic bearing parts are possible during mass production.

This application is a continuation-in-part application of Application Ser. No. 09/629,627 filed Jul. 31, 2000.

### BACKGROUND OF THE INVENTION

1. Field of the Invention

The present invention relates to methods and apparatuses for forming grooves for hydrodynamic bearings by electrochemical machining. The present invention also relates to methods and apparatuses for inspecting or measuring the grooves.

2. Description of the Related Art

High-speed stable rotation has been recently required for motors used in disk apparatuses and image scanners. In these motors, conventional ball bearings are being replaced by hydrodynamic bearings having superior high-speed rotatability and stability. The hydrodynamic bearing has a structure in which a fine gap for holding a fluid such as oil is formed between a shaft (including a thrust plate) and a sleeve, and a hydrodynamic groove is formed on the inner surface of the sleeve and/or the outer surface of the shaft. When the motor rotates, the hydrodynamic groove generates a dynamic pressure in the fluid to generate a holding force for supporting the rotating part of the motor. The hydrodynamic groove may have various shapes, such as herringbone and spiral.

Precise formation of the hydrodynamic grooves is important so that the hydrodynamic bearing shows performance required by a design specification. In general, the hydrodynamic grooves have a fine pattern. In particular, as spindle motors used in hard disks decrease in size, the pattern of the hydrodynamic grooves become finer. For example, for a motor driving a 3.5-inch hard disk, a shaft has a diameter of 2 mm and a hydrodynamic groove must have a depth of approximately 10 μm. Machining of such hydrodynamic grooves is generally required to have a finished accuracy in the sub-micron order.

In recent years, electrochemical machining has been used for forming such hydrodynamic grooves. One of the prior arts is UK Patent Application GB2319741A invented by Frank Peter Wardle. In electrochemical machining, a machining electrode having a shape corresponding to a designed groove pattern is positioned in close proximity to a workpiece so as to confront the surface of the workpiece in an electrolyte solution, such as a sodium chloride (NaCl) solution or sodium nitrate (NaNO₃) solution. A current flows between the machining electrode and the workpiece so that the surface of the workpiece is electrochemically dissolved to form an engraved pattern corresponding to the shape of the machining electrode.

In the past, it was believed that it was difficult to form precise shapes on a workpiece by electrochemical machining. As a result of subsequent research, however, highly precise machining has been enabled by (1) fixing the distance between the machining electrode and the workpiece, (2) controlling the degree of machining based on the total amount of electricity to be applied to the workpiece, and (3) circulating the electrolyte solution to make the machining conditions uniform. One of known and advanced technologies for forming hydrodynamic grooves using this method is shown in Japanese Unexamined Patent Application Publication No. 10-86020.

In this electrochemical machining technology, so-called open loop control is employed. That is, the total amount of electricity (the product of current and time) required for the machining is preliminarily determined and the electrochemical machining is performed only based on the total amount. When the technology is applied to a mass-production process, it is difficult to stably produce hydrodynamic grooves on many workpieces with high accuracy for a long time. That is, the machining electrode on the electrochemical machining device becomes worn during electrochemical machining of many workpieces, and the actual concentration of the electrolyte solution and the metallic ion contents, dissolved into the electrolyte solution, vary. As a result, the actual machining conditions change. To form hydrodynamic grooves precisely according to the design specification during mass production, machining conditions of the electrochemical machining apparatus must be regulated with time. However, in the conventional machining apparatus, the machining conditions set for the optimum settings at the initial stage are not kept to those setting throughout the mass production process.

### SUMMARY OF THE INVENTION

Accordingly, it is an object of the present invention to provide a method and apparatus for electrochemical machining which can stably and precisely produce fine hydrodynamic grooves during mass production according to a design specification.

Another object of the present invention is to provide a method and apparatus which inspects and evaluates the shapes of hydrodynamic grooves based upon design specifications.

In the method and the apparatus for electrochemical machining in accordance with the present invention, a workpiece is extracted every predetermined number of cycles from workpieces continuously produced by mass production, and hydrodynamic grooves on the extracted workpiece are inspected with respect to a plurality of inspection points on the grooves. Differences between values observed on the hydrodynamic grooves and the design specification values are stored as machining errors with respect to the plurality of inspection points. Also, the electrochemical machining apparatus includes a setting modification table which was experimentally determined in advance and which contains data of an amount of modification for settings for minimizing differences between the observed values of the hydrodynamic grooves on the extracted workpiece and the design specification values. The amount of modification for the settings on the machining apparatus are determined based on the observed machining error with reference to the setting modification table. A hydrodynamic groove according to the design specification is formed under the modified settings in the subsequent machining process.

The modified settings on the electrochemical machining apparatus include a current and a voltage applied during the electrochemical machining, a gap between a working electrode and the workpiece, the shape of the working electrode, a flow rate and a concentration of the electrolyte solution, and combinations thereof. As the settings on the machining apparatus are always optimized corresponding to the design specifications, the electrochemical machining apparatus can form fine hydrodynamic grooves during mass production.

### BRIEF DESCRIPTION OF THE DRAWINGS

FIG. 1 is a schematic diagram of an electrochemical machining apparatus according to the present invention;

FIG. 2 is a flow chart showing a process for modifying machining conditions in the electrochemical machining apparatus shown in FIG. 1;

FIG. 3 is a block diagram of the internal structure of a setting-modifying unit for automatically modifying the settings on the electrochemical machining apparatus;

FIG. 4 is an illustration showing an internal diameter measuring apparatus for a cylinder;

FIG. 5 is an illustration showing another internal diameter measuring apparatus for a cylinder;

FIG. 6 is an illustration showing a critical part of still another internal diameter measuring apparatus for a cylinder;

FIG. 7 is an illustration showing a critical part of a further internal diameter measuring apparatus for a cylinder; and

FIG. 8 is an illustration showing a critical part of a still further internal diameter measuring apparatus for a cylinder.

### DESCRIPTION OF THE PREFERRED EMBODIMENTS

A method and apparatus for electrochemical machining according to an embodiment of the present invention will now be described with reference to the drawings.

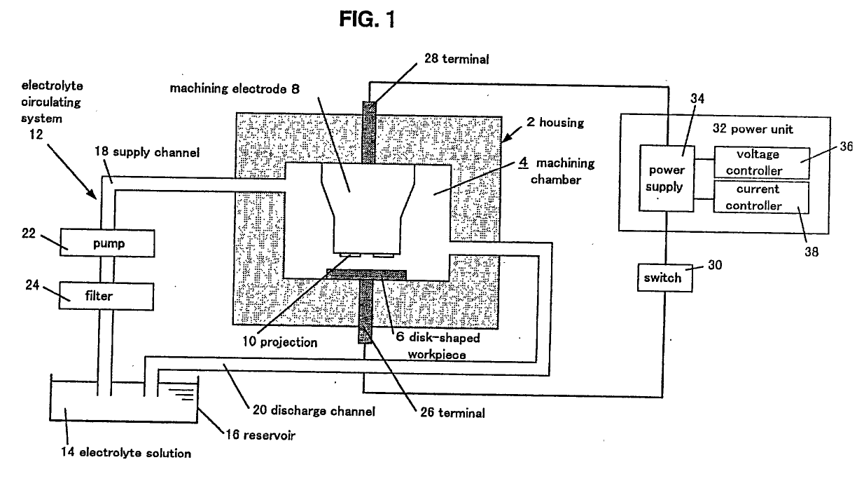

FIG. 1 shows an embodiment of an electrochemical machining apparatus for forming a hydrodynamic groove on a thrust plate surface. A housing 2 forms a machining chamber 4 which is substantially hermetically sealed and is filled with an electrolyte solution. A machining electrode 8 for electrochemical machining is arranged in the machining chamber 4 and is electrically connected to a terminal 28 which passes through a wall of the machining chamber 4 for supplying electrical energy to the electrode 8. A disk-shaped workpiece 6 for a thrust plate is arranged to face the machining electrode 8 with a fine gap therebetween. The housing 2 can be opened (not shown in the drawing) for getting the workpiece 6 in and out of the housing 2. The workpiece 6 is electrically connected to another terminal 26 for supplying electrical energy. The terminal 26 passes through another wall of the machining chamber 4.

A surface (the bottom surface as viewed in FIG. 1) of the machining electrode 8 is provided with a projection 10 of which shape corresponds to the shape of a hydrodynamic groove to be formed. The projection 10 protrudes toward a surface (the upper face) of the workpiece 6. During the electrochemical machining, a clearance between the tip of the projection 10 and the surface of the workpiece 6 is maintained at, for example, approximately 0.1 to 0.3 mm. The shape of the hydrodynamic groove is generally a herring bone or a spiral. The machining electrode 8 and the projection 10 are generally made of stainless steel, and the workpiece 6, such as a thrust plate, a shaft, or a sleeve, is formed of stainless steel or a copper alloy.

The entire surface of the machining electrode 8, except for the projection 10, may be covered with a nonconductive material so that the projection 10 functions more precisely as a working electrode.

The present invention is not limited to the configuration and structure as shown in FIG. 1. For example, a fixing mechanism for fixedly supporting the machining electrode 8 may be provided between the housing 2 and the machining electrode 8. The fixing mechanism may be movable relative to the workpiece 6 within a predetermined range before the machining electrode 8 is fixed.

The electrochemical machining apparatus in accordance with the embodiment of the present invention includes an electrolyte circulating system 12 for constantly supplying homogeneous electrolyte solution to the machining chamber 4 in the housing 2. The electrolyte circulating system 12 includes a reservoir 16 containing a large amount of homogeneous electrolyte solution 14, a pump 22 for supplying the homogeneous electrolyte solution 14 in the reservoir 16 to the machining chamber 4, a filter 24 for removing insoluble impurities, such as dust, in the electrolyte solution 14, a supply channel 18 for supplying the electrolyte solution 14 to the machining chamber 4, and a discharge channel 20 for discharging the electrolyte solution 14 in the machining chamber 4 to the reservoir 16.

During electrochemical machining, metallic ions are dissolved from the workpiece 6 into the electrolyte solution 14, and the concentration of the impurity increases in the vicinity of the surface of the workpiece. If the electrochemical machining is continued without circulation of the electrolyte solution 14, the electrochemical machining is not precisely achieved in accordance with the design specification, due to substantial changes in the machining conditions. The electrolyte circulating system 12 discharges the electrolyte solution 14 having an increased concentration of impurity, from the machining chamber 4 and supplies homogeneous electrolyte solution 14 to the machining chamber 4. Thus, electrochemical machining is performed under constant machining conditions, and a precise hydrodynamic groove can be formed.

An example of the electrolyte solution is an aqueous sodium nitrate (NaNO₃) solution. The reservoir 16 may be provided with a purifying unit (not shown in the drawing) for removing impurities from the electrolyte solution 14 so as to maintain the homogeneity of the electrolyte solution 14.

Electrical power (the product of current and voltage) is applied between the machining electrode 8 and the workpiece 6 through the two terminals 26 and 28 and a switch 30 from a power supply unit 32. The power supply unit 32 includes an electrical power supply 34, a voltage controller 36, and a current controller 38. The electrical power supply 34 produces a direct current with a predetermined voltage for machining. The voltage controller 36 and the current controller 38 independently change the voltage and the current, respectively, of the electricity supplied from the electrical power supply 34, in response to a command from a machining-controlling unit (not shown in the drawing). That is, the observed size (described later) of the hydrodynamic groove formed is compared to the size defined in the design specification, and the machining conditions are changed based on the difference therebetween. The voltage between the machining electrode 8 and the workpiece 6 may be a pulsed voltage. The above-described control may be performed by a manual operation.

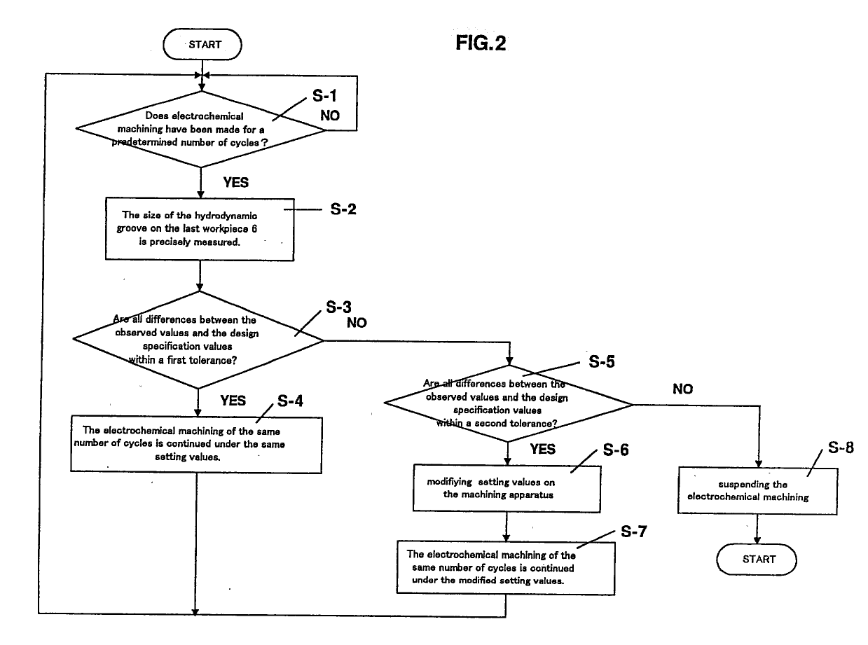

With reference to FIGS. 1 and 2, an embodiment of a machining method in accordance with the present invention will now be described. A new workpiece 6 is put into the opened housing 2 and fixed precisely at a predetermined position therein. The workpiece 6 is thereby electrically connected to the terminal 26. The machining chamber 4 is closed and the machining chamber 4 is filled with the electrolyte solution 14 by operation of the pump 22. The position of the machining electrode 8 is adjusted, if necessary. A predetermined current at a predetermined voltage flows between the terminal 26 and the terminal 28 from the electrical power supply 34 for a predetermined time, under the control of a machining controlling unit (not shown in the drawing). As an example of electrochemical machining settings, the gap between the surface (upper face in FIG. 1) of the workpiece 6 and the tip of the projection 10 of the machining electrode 8 is 0.1 mm, the voltage is 10 V, the current is 10 A, and the application time (the time period for the switch 30 to be closed) is 1 s. The pump 22 is continuously operated during the electrochemical machining so as to supply the electrolyte solution 14 having a predetermined concentration to the interior of the machining chamber 4. Electrochemical machining is thereby achieved under the predetermined machining settings. When voltage pulses are applied, an application time period corresponds to the accumulated total on-time of applied pulses. For example, when voltage pulses with a 10-msec on-time and a 90-msec off-time are applied, the sum of 100 pulses corresponds to one second.

After the electrochemical machining of the workpiece 6 is completed, the electrolyte solution in the machining chamber 4 is withdrawn from the chamber 4, and the housing 2 is opened to remove the workpiece 6. A subsequent workpiece 6 is fixed to the predetermined position in the machining chamber 4, and the above machining operation is repeated to form a hydrodynamic groove of the hydrodynamic bearing on each workpiece.

After electrochemical machining has been made for a predetermined number of cycles (for example 30 cycles) under the same settings on the electrochemical machining apparatus (step S-1 in FIG. 2), the machining controlling unit instructs the subsequent step S-2 to be performed. In the step S-2, the sizes of the hydrodynamic grooves on the last workpiece 6 (30th workpiece) are precisely measured. In the measurement, for example, the width and the depth of the hydrodynamic groove are measured at several positions manually and/or automatically using an electronic micrometer, an air micrometer, or a laser pickup.

The electronic micrometer includes a sensing probe, a magnetic body and a coil. The sensing probe has a thin end which is put in touch with a surface of the groove to be measured, and has the other end to which the magnetic body is fixed. The sensing probe can move around a supported point which is located at a middle portion between the thin end and the other end of the sensing probe. The coil surrounds the magnetic body. A minute displacement of the thin end of the sensing probe causes a little change of inductance value of the coil. By measuring the change of a current in the coil, the electronic micrometer determines the precise dimension of the minute displacement.

The air micrometer measures the size by means of a difference in air pressure between an air blowing port provided at the tip of a probe and an air-supply side. The laser pick-up exactly measures the size of the optical path using a phase difference and an interference angle between incident laser light and reflected laser light. Any other measuring unit may also be used. The predetermined number of cycles is determined depending on the properties of the electrochemical machining apparatus, such as the life time of the electrolyte solution and the life time of the machining electrode, and the shape and the accuracy of the hydrodynamic groove to be formed.

After the sizes of the hydrodynamic grooves on the workpiece 6 are measured at a plurality of positions, the data are compared respectively with the design specification values in the subsequent step S-3. When all differences between the observed values and the design specification values lie within a first tolerance, the machining controlling unit performs the process of step S-4 so that electrochemical machining of the same number of cycles is continued under the same setting values on the electrochemical machining apparatus. Herein, when the first tolerance is 0.5 μm (micro-millimeter), for example, the result of the measuring is permitted when all the differences between the observed values and the design specification values are within 0.5 μm (micro-millimeter) for all measured positions.

When a difference exceeding the first tolerance is found, the machining controlling unit performs step S-5 in which the observed values are compared to a predetermined second tolerance. Herein, when the second tolerance is 1.0 μm (micro-millimeter), for example, the result of the measuring is permitted when all the differences between the observed values and the design specification values are within 1.0 μm for all measured positions.

When all differences between the observed values and the design specification values lie within a second tolerance, the machining controlling unit performs the process of step S-6 so that modified setting values on the machining apparatus are determined with reference to a setting modification table containing machining conditions depending on the difference between the observed values and the design specification value. These setting values are set in the electrochemical machining apparatus shown in FIG. 1.

When a difference exceeding the second tolerance is found, the machining controlling unit performs step S-8 for suspending the electrochemical machining. The workpiece 6 in such a case is classified as an unsatisfactory product, and the production line is thoroughly improved based on the review of the machining conditions, inspection of the working electrode 8 and the projection 10, and replacement thereof, if necessary.

The setting modification table includes modified settings which minimize a machining error according to the design specification value when the machining error occurs during the electrochemical machining under certain machining conditions. With respect to the difference between the measured value and the design specification value at each position on the hydrodynamic groove, the best setting values are stored in the setting modification table. If the setting values read from the setting modification table are set to the electrochemical machining apparatus, the apparatus may form a groove having the design specification value on a workpiece. These modified setting values are predetermined by experiments and the like. This table includes modified setting values corresponding to all possible errors. Thus, searching of this table based on the error enables retrieval of modified setting values for the electrochemical machining apparatus. For example, the table includes data where the current is increased by 5 percent and the electricity applied time is increased by 3 percent when a certain position of the hydrodynamic groove formed is 0.7 μm (micro-millimeter) narrower than the design specification value.

An example when a pulsed voltage is applied and when the settings to the electrochemical machining apparatus are changed based on the total numbers of pulses to be supplied will now be described. The depth of the groove which is formed by one pulse (the depth defined as the unit machining depth d) and which is near the design specification value is determined and is stored in the setting modification table. The shape of the groove on the workpiece after machining under predetermined settings is measured and the value of the groove compared to the design specification values.

When the (positive or negative) difference between the depth of the groove on the workpiece and that of the design specification lies within the value between the first tolerance and the second tolerance, the number of pulses is decreased or increased in the subsequent electrochemical machining process, depending on the result what the difference of depths divided by the unit depth D₀ is. This process facilitates control during mass production and achieves groove machining with reduced cost which are not realized for conventional open-loop control.

As described above, the hydrodynamic groove of the machined workpiece is precisely measured every predetermined number of cycles and is compared to the design specification value of the hydrodynamic groove. When the difference lies within a predetermined range, the machining settings are changed to the optimized values. Thus, the machining settings are changed to the optimized values, which are suitable for machining the hydrodynamic groove having the design specification value, when the actual machining conditions are varied due to a change in the electrolyte solution concentration over time and wear of the working electrode. The electrochemical machining apparatus always performs stable machining of the hydrodynamic groove based on the design specification.

In the above embodiments, a plurality of positions of the formed hydrodynamic groove are compared to the design specification value. Alternatively, a typical point of the hydrodynamic groove may be compared to the design specification for the evaluation shown in FIG. 2.

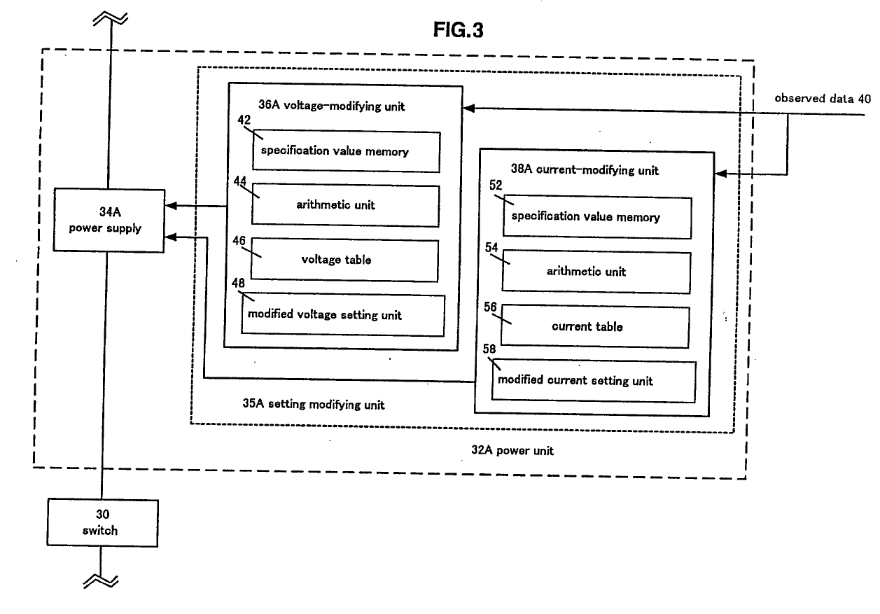

FIG. 3 is a block diagram of the internal structure of a setting modifying unit 35 for automatically modifying the machining voltage and the machining current among the machining settings. The internal operation of a voltage-modifying unit 36A will now be described. Observed data 40 of the hydrodynamic groove formed at a predetermined position or predetermined positions is input to the voltage-modifying unit 36A. The observed data 40 of the machined component (workpiece 6) extracted at the step S-2 in FIG. 2 is automatically measured by the operation of a measuring unit, such as an electronic micrometer, using a known technology, such as a robot. The observed data 40 is compared with the design specification value stored in a specification value memory 42 in an arithmetic unit 44 to calculate a difference. A voltage table 46 includes data of the amount of voltages to be modified corresponding to all possible differences. With reference to the voltage table 46, an optimum machining voltage is output according to the difference calculated in the arithmetic unit 44. A modified voltage setting unit 48 receives the optimum machining voltage and gives a command for modifying the voltage to an electrical power supply 34A. By the above operation, the electrochemical machining conditions are changed for the subsequent workpiece so as to form a hydrodynamic groove which is not different from the design specification value.

A current-modifying unit 38A in FIG. 3 independently modifies the machining current by a similar operation as in the voltage-modifying unit 36A.

In addition to the current and the voltage, setting parameters for the above modification of the machining conditions may include the gap between the working electrode and the workpiece, the shape of the working electrode, the flow rate and the concentration of the electrolyte solution, and combinations thereof, in order to more precisely modify the machining conditions and to further improve the precision of the hydrodynamic groove formed.

In FIG. 2, a third tolerance may be included in addition to the first and second tolerances so as to refer to a first setting modification table when the difference lies between the first tolerance and the second tolerance and to refer to a second setting modification table when the difference lies between the second tolerance and the third tolerance, for modifying the machining conditions. The third tolerance facilitates the modification of the machining settings with higher accuracy and stable electrochemical machining of high-quality hydrodynamic grooves.

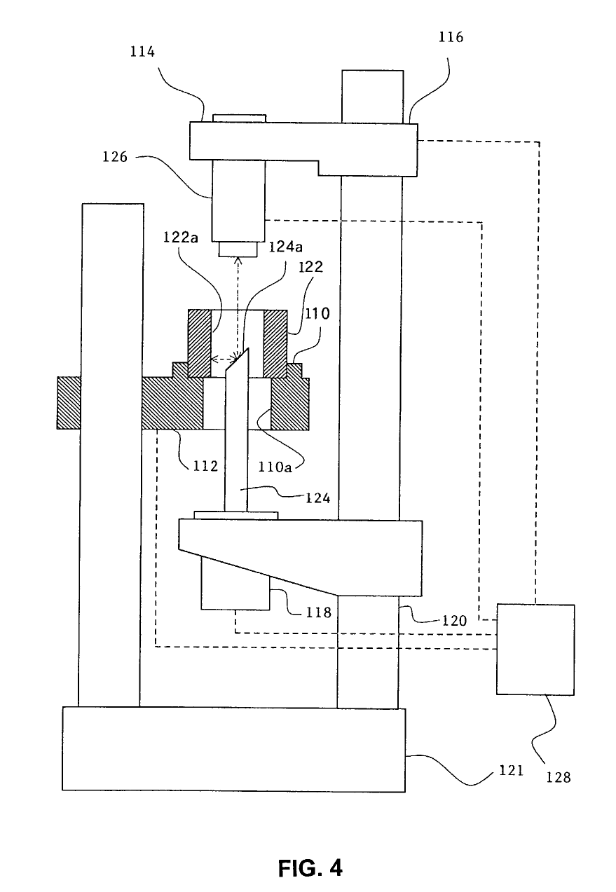

FIG. 4 shows a groove-shape-inspection apparatus to be used after electrochemical machining. The groove-shape-inspection apparatus according to the present embodiment inspects, with an optical means, and evaluates the shapes of hydrodynamic grooves formed in an inner surface of a sleeve of hydrodynamic bearings by comparing with the design values.

Such an internal diameter measuring apparatus for a cylinder includes a measuring-object lifting device 112 for raising and lowering a measuring-object holder 110, a vertically movable focusing-device 116 for raising and lowering a laser-displacement-meter holder 114, and a supporting platform 120 for supporting a reflection-plane-holder rotating device 118. These components stand on a base 121.

The measuring-object holder 110 is provided with a vertical through-hole 110a and holds, above the through-hole 110a, a sleeve 122 as a measuring object by holding means such as a chuck. Hydrodynamic grooves (not shown in the drawing) for generating dynamic pressure are formed in a cylindrical inner surface 122a of the sleeve 122 by electrochemical machining. The inner diameter of the cylindrical inner surface 122a of the measuring object is, for example, 2 mm or greater.

The measuring-object lifting device 112 raises or lowers the measuring-object holder 110 by a predetermined distance with a motor (not shown in the drawing).

The reflection-plane-holder rotating device 118 rotates an upward protruding cylindrical reflection-plane holder 124, which has a reflection plane 124a at an upper end thereof, at a predetermined rotational speed by a rotation-driving motor (not shown in the drawing). The rotational speed may be, for example, on the order of 0.5 revolutions/second to 10 revolutions/second.

The vertically movable focusing-device 116 raises and lowers the laser-displacement-meter holder 114, which holds a laser displacement meter 126, by driving a motor for focusing (not shown in the drawing).

The laser displacement meter 126 emits a laser beam in a predetermined direction and detects the displacement of a part of the measuring object in accordance with a reflected beam returning along the same axis as that of the emitted laser beam.

A controlling and analyzing device 128 controls the vertical movement of the measuring-object lifting device 112 and the vertically movable focusing-device 116, the rotational movement of the reflection-plane-holder rotating device 118, and the measuring operation of the laser displacement meter 126. The controlling and analyzing device 128 computes three-dimensional shapes and the like of the hydrodynamic grooves (each having a depth of, for example, on the order of 5 to 20 μm) formed in the cylindrical inner surface 122a of the sleeve 122 as a measuring object from the measurement data of the laser displacement meter 126, the vertical movement data of the measuring object, and the rotation data of the reflection plane 124a.

The above-described operations are performed on the condition that the axis of the laser beam emitted by the laser displacement meter 126, the axis of the reflection-plane holder 124, the rotation axis of the reflection-plane-holder rotating device 118, and the axis of the sleeve 122 are coincide with each other, and the reflection plane 124a is inclined by 45 degrees with respect to the axis of the laser beam.

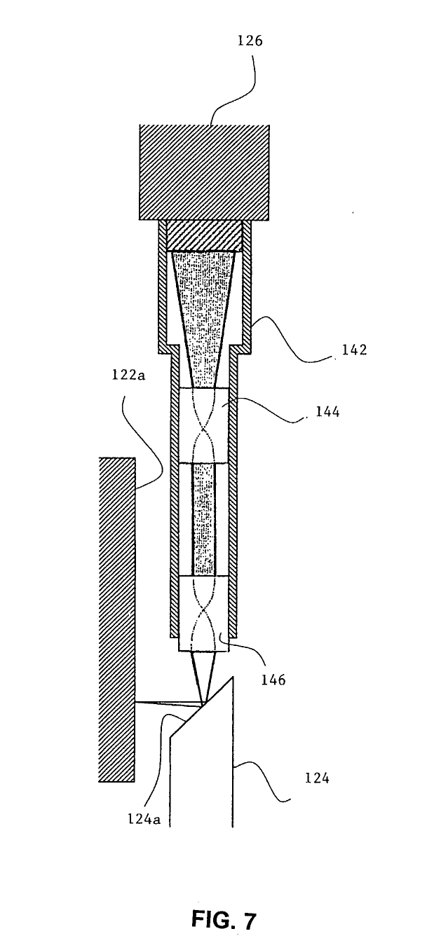

As a result, the laser beam which is downwardly emitted by the laser displacement meter 126 reflects at the reflection plane 124a which is inclined by 45 degrees with respect to the axis of the laser beam, thereby changing its direction by 90 degrees, and advances in the horizontal direction, as shown in FIG. 7. Then, the laser beam is applied to the cylindrical inner surface 122a of the sleeve 122 perpendicular to the axis thereof. The laser beam is reflected in the same horizontal direction but in an opposite direction reflects again at the reflection plane 124a and thereby changes its direction by 90 degrees and goes upward back to the laser displacement meter 126 along the same axis of the emitted laser beam. The laser displacement meter 126 computes the displacement of the cylindrical inner surface 122a in accordance with the thus returned reflection beam.

When the sleeve 122 as a measuring object is held by the holder 110, the laser beam reflected at the reflection plane 124a is applied to the cylindrical inner surface 122a of the sleeve 122 perpendicular to the axis thereof. The vertically movable focusing-device 116 is controlled in advance so that the laser beam focuses on the cylindrical inner surface 122a. The measuring-object holder 110 is set in a position where the laser beam is applied to a scanning-start position of the cylindrical inner surface 122a at the axially lower end (or at the upper end) thereof. Then, the measuring-object lifting device 112 is raised (or lowered) at a given speed while maintaining the distance in the axial direction between the laser displacement meter 126 and the reflection-plane holder 124.

While the reflection-plane-holder rotating device 118 rotates the reflection-plane holder 124 at a given angular speed, the laser displacement meter 126 detects the displacement of parts of the measuring object by using the laser beam consecutively at a given sampling speed (for example, 500 Hz to 1 kHz). In this operation, the displacement of the cylindrical inner surface 122a can be detected consecutively at a high speed at every given angle along a spiral having a given pitch in accordance with the movement of the cylindrical inner surface 122a in the radial direction thereof, or the movement of the reflection plane 124a in the rotational direction thereof and the movement of the sleeve 122 in the axial direction thereof.

The pitch of the spiral is set according to the rising or lowering speed of the measuring-object lifting device 112 and the rotational speed of the reflection-plane-holder rotating device 118. The controlling and analyzing device 128 can compute three-dimensional shapes of the hydrodynamic grooves formed in the cylindrical inner surface 122a of the sleeve 122 in accordance with the data detected by the laser displacement meter 126, the position of the measuring-object lifting device 112, and the data regarding the rotational angle of the reflection-plane-holder rotating device 118.

The shapes of the hydrodynamic grooves may be detected by the laser beam by alternately stopping and raising (or lowering) the measuring-object lifting device 112 instead of continuously raising (or lowering) the same. That is, when the measuring-object lifting device 112 suspends its movement, the laser displacement meter 126 performs detection while the reflection-object-holder rotating device 118 rotates by one turn. Then, the measuring-object lifting device 112 rises (or lowers) by a given distance and stops its movement, at which position the laser displacement meter 126 performs detection while the reflection-object-holder rotating device 118 rotates by another turn. After these operations are repeatedly performed, the data detected around the periphery can be obtained at every given position along the axis, whereby the controlling and analyzing device 128 can compute the three-dimensional shapes of the hydrodynamic grooves formed in the cylindrical inner surface 122a of the sleeve 122 in the same manner as described above.

The internal diameter measuring apparatus for a cylinder can be also arranged such that the sleeve 122 as a measuring object rotates about the axis thereof instead of rotating the reflection-plane holder 124. The laser displacement meter 126 and the reflection-plane holder 124 may be raised or lowered with the distance therebetween in the axial direction being unchanged, instead of the measuring-object holder 110 being raised or lowered.

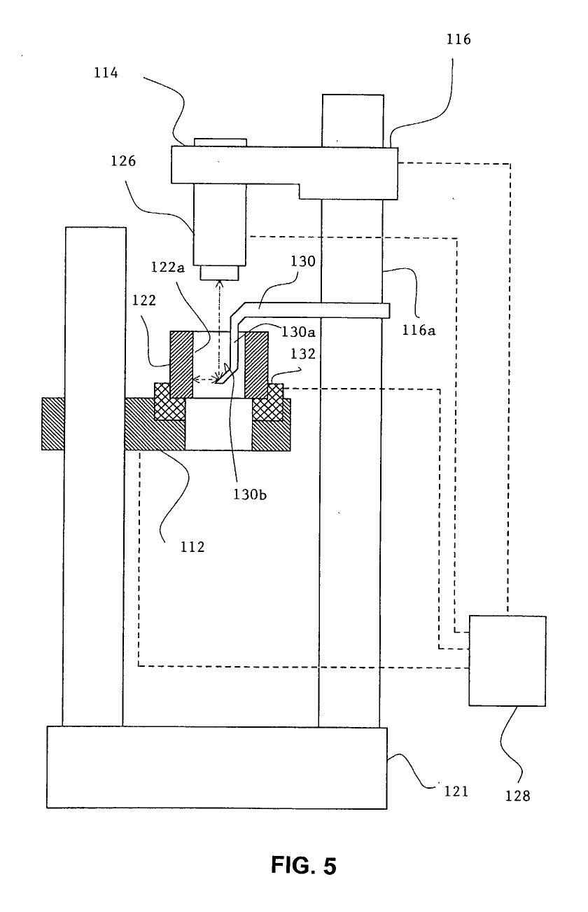

FIG. 5 shows an internal diameter measuring apparatus for a cylinder as a groove-shape-inspection apparatus according to another embodiment of the present invention.

The internal diameter measuring apparatus for a cylinder shown in FIG. 5 differs from that shown in FIG. 4 in points described below.

(1) The reflection-plane-holder rotating device 118 and the upward protruding cylindrical reflection-plane holder 124 are not included.

(2) Instead of these, a reflection plane 130b inclined by 45 degrees with respect to the axis of the laser beam is provided at a lower end of a downward protruding part 130a protruding from an end of a reflection-plane holder 130 which is fixed horizontal to a supporting post 116a of the vertically movable focusing-device 116 for raising and lowering the laser-displacement-meter holder 114.

(3) A measuring-object holder 132 which holds the sleeve 122 can rotate the sleeve 122 about the axis thereof by an angle corresponding to an input pulse signal of a rotationally driving step motor (not shown in the drawing).

The features corresponding to the above points are described below.

(a) The downward protruding part 130a of the reflection-plane holder 130 is inserted into the sleeve 122 from the upper open end thereof, the sleeve 122 being supported by the measuring-object holder 132.

(b) Since the measuring-object holder 132 can rotate the sleeve 122 relative to the reflection plane 130b, the detection can be performed in the same manner as described above even when an end in the axial direction (the lower end in the drawing) of the sleeve 122 is closed.

(c) Since the laser-beam reflecting plane 130b does not move, the initial control of the optical axis and the reflection plane can be performed easily.

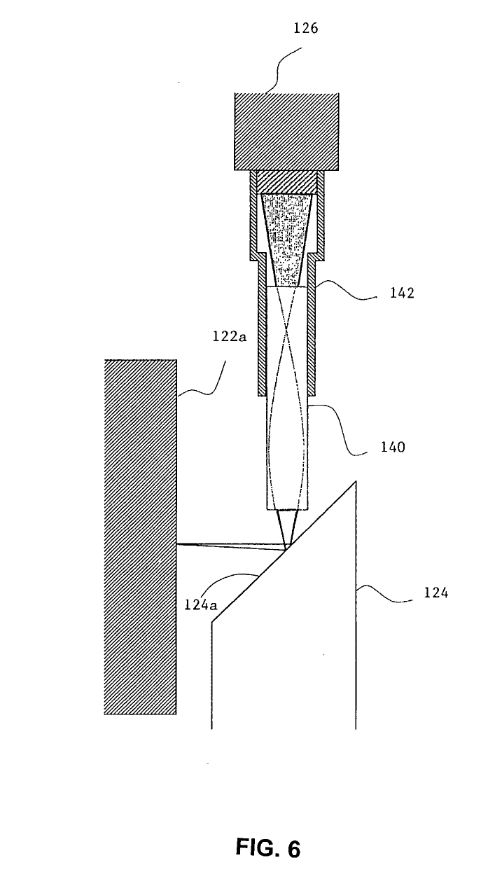

FIGS. 6 to 8 show condenser lens systems according to embodiments, each used between the laser displacement meter 126 and the laser-beam reflecting plane 124a or 130b in the above embodiments, respectively.

FIG. 6 is an illustration of a critical part of an internal diameter measuring apparatus for a cylinder for describing an embodiment of the condenser lens system. In this case, a cylindrical gradient index lens 140 as a condenser lens is provided inside a cylindrical holder 142. A laser beam emitted from the laser displacement meter 126 once condenses and then diverges inside the lens 140. The laser beam from the lens 140 again condenses focusing on the cylindrical inner surface 122a, reflects at the cylindrical inner surface 122a, then, at the reflection plane 124a, is transmitted by the lens 140, and returns to the laser displacement meter. With this arrangement, the focal distance of the laser beam emitted by the laser displacement meter 126 is practically increased compared with a case in which the gradient index lens 140 is not provided. Therefore, even when the inner diameter of the sleeve 122 to be inspected is small and the focus-control distance of the laser beam cannot be sufficiently provided, the distance can be ensured by the gradient index lens 140 in the vertical direction (the axial direction) in FIG. 6, whereby the shapes of the hydrodynamic grooves formed in the sleeve 122 can be detected.

FIG. 7 is an illustration of a critical part of the internal diameter measuring apparatus for a cylinder for describing a further embodiment of the condenser lens system. In this case, two gradient index lenses 144 and 146 as condenser lenses are provided away from each other in the axial direction such that the laser beam is collimated between the two lenses, whereby the focal distance of the laser beam can be practically significantly increased. The upper gradient index lens 144 focuses the laser beam therein and emits the same as a collimated beam from the lower end thereof. The lower gradient index lens 146 focuses the laser beam therein and emits the same as a condensing laser beam from the lower end thereof.

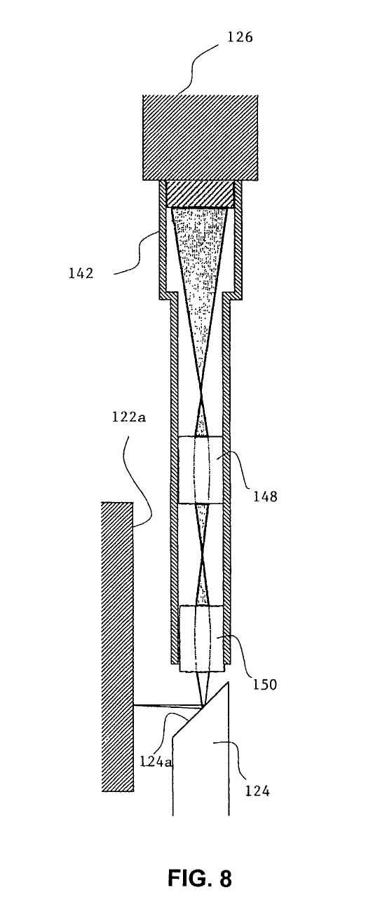

FIG. 8 is an illustration of a critical part of the internal diameter measuring apparatus for a cylinder for describing a still further embodiment of the condenser lens system. In this case, two gradient index lenses 148 and 150 are provided away from each other in the axial direction in the same manner as in the above embodiment of the lens system. These lenses convert incident divergent light fluxes into condensing light fluxes in each lens and condense the light fluxes outside each lens. As a result, the focal distance can be significantly increased in the axial direction in the same manner as in the above condenser lens system, and consequently, the shapes of the hydrodynamic bearings formed on the inner surface of a fine sleeve can be accurately inspected.

The terms “upper” and “lower” referred to in the description of the above embodiments, which are used for describing positions, are conveniently used only for description with reference to the drawings, and do not practically specify conditions for use or the like. The description of means of solving the problems of the present invention, including examples of embodiments of the present invention, are principally applicable to the description of the above-described embodiments.

By using the internal diameter measuring apparatus for a cylinder and in the method of measuring the internal diameter of a cylinder, according to the present invention, the internal diameter of a cylindrical inner surface or the displacement thereof can be accurately measured or detected at high speed and the cylindrical inner surface can be inspected by a displacement meter disposed at the outside of the cylindrical inner surface of a hydrodynamic bearing of a measuring object.

It will be appreciated by those skilled in the art that various modifications and alterations may be made in the preferred embodiment disclosed herein without departing from the scope of the invention. Accordingly, the scope of the invention is not to be limited to the particular invention embodiments discussed above, but should be defined only by the claims set forth below and equivalents thereof.

1. A method of producing fluid dynamic bearing parts by means of an electrochemical machining apparatus having one or more settings to control machining, each of the bearing parts having a cylindrical shape which has an axial line as a center line and having fluid dynamic grooves on an internal circumference surface of the bearing part, the method comprising the steps of production processes and regulation processes,
each production process including the steps of:
holding a machining electrode having a shape corresponding to a set of grooves to be machined;
holding the bearing part to confront a machining surface of the machining electrode with a predetermined clearance;
supplying electrolyte solution to fill the predetermined clearance, between the machining electrode and the bearing part, with the electrolyte solution; and
supplying electric power to the machining electrode and the bearing part, the electric power composed of machining voltage, machining current and total supplying time, and
each regulation process including the steps of:
extracting one bearing part already formed with the sets of grooves, after producing a predetermined number of bearing parts in the production process;
measuring shapes of the grooves on the extracted bearing part;
comparing the shapes of the groove on the extracted bearing part with the shape of a design specification; and
changing settings on the electrochemical machining apparatus in accordance with a result of the comparison,
wherein the step of said measuring shapes of the grooves including the steps of:
holding the extracted bearing part in a position where the center line of the bearing part is kept in line with a part of a beam path of an emitted optical beam;
generating the emitted optical beam to measure outline shapes of fluid dynamic bearing grooves;
controlling the emitted optical beam to be focused on and to be emitted substantially perpendicular to the internal circumference surface of the bearing part, and controlling a beam reflecting off the internal circumference surface of the bearing part to be returned on a beam path substantially corresponding to the beam path of the emitted optical beam;
detecting a length in a radial direction between an optical beam emitted point on the internal circumference surface of the bearing part and the center line by comparing the reflected optical beam with the emitted optical beam; and
shifting the optical beam emitted point on the internal circumference surface of the bearing part to a predetermined position to measure another point on the internal circumference surface of the bearing part.

2. A method according to claim 1, wherein the step of changing the settings on the electrochemical machining apparatus, includes changing the setting of at least one or any combination of machining voltage, machining current, total supplying time, a total amount of electricity corresponding to time integration of machining current, a gap between the machining electrode and the bearing part to be machined, concentration of the electrolyte solution, a flow rate of the electrolyte solution and the shape of the electrode.

3. A method according to claim 1, further comprising the step of supplying the electric power by a predetermined number of voltage pulses depending on the design specification, each voltage pulse having a predetermined voltage and on-duration time, and in the changing settings step of the regulation process, further comprising the step of increasing or decreasing the number of the voltage pulses depending on the result of the comparison.

4. A method of producing fluid dynamic bearing parts by means of an electrochemical machining apparatus having one or more settings to control machining, the bearing part having a cylindrical shape which has a part axial line as a center line and having fluid dynamic grooves on an internal circumference surface of the bearing part, the method comprising the steps of production processes and regulation processes,
each production process including the steps of:
holding a machining electrode having a shape corresponding to a set of grooves to be machined;
holding the bearing part to confront a machining surface of the machining electrode with a predetermined clearance;
supplying electrolyte solution to fill the predetermined clearance, between the machining electrode and the bearing part, with the electrolyte solution; and
supplying electric power to the machining electrode and the bearing part, the electric power composed of machining voltage, machining current and total supplying time; and
each regulation process including the steps of:
extracting one bearing part already formed with the sets of grooves, after producing a predetermined number of bearing parts in the production process;
measuring shapes of the grooves on the extracted bearing part;
comparing the shapes of the groove on the extracted bearing part with the shape of a design specification; and
changing settings on the electrochemical machining apparatus in accordance with a result of the comparison,
wherein the measuring steps uses a measuring apparatus having an apparatus axial line corresponding to the center line of the bearing part about which the bearing parts are rotating for measurement, the step of measuring shapes of the grooves including the steps of:
holding the extracted bearing part in a position where the part axial line is kept in line with the apparatus axial line;
generating an emitted laser beam;
controlling the emitted laser beam to be focused on and to be emitted substantially perpendicular to the internal circumference surface of the bearing part, and controlling a beam reflecting off the internal circumference surface of the bearing part to be returned on a beam path substantially corresponding to a path of the emitted laser beam;
detecting a length in a radial direction between an laser beam emitted point on the internal circumference surface of the bearing part and the apparatus axial line by comparing the reflected laser beam with the emitted laser beam; and
shifting the laser beam emitted point on the internal circumference surface of the bearing part to a predetermined position to measure another point on the internal circumference surface of the bearing part.

5. A method according to claim 4, wherein the step of changing the settings on the electrochemical machining apparatus, includes changing the settings of at least one or any combination of machining voltage, machining current, total supplying time, a total amount of electricity corresponding to time integration of machining current, a gap between the machining electrode and the bearing part to be machined, concentration of the electrolyte solution, a flow rate of the electrolyte solution and the shape of the electrode.

6. A method according to claim 4, further comprising the step of supplying the electric power by a predetermined number of voltage pulses depending on the design specification, each voltage pulse having a predetermined voltage and on-duration time, and in the changing settings step of the regulation process, further comprising the step of increasing or decreasing the number of the voltage pulses depending on the result of the comparison.

7. A method of producing fluid dynamic bearing parts by means of an electrochemical machining apparatus having one or more settings to control machining, each of the bearing parts having a cylindrical shape which has a part axial line as a center line and having fluid dynamic grooves on an internal circumference surface of the bearing part, the method comprising the steps of production processes and regulation processes,
each production process including the steps of:
holding a machining electrode having a shape corresponding to a set of grooves to be machined;
holding the bearing part to confront a machining surface of the machining electrode with a predetermined clearance;
supplying electrolyte solution to fill the predetermined clearance, between the machining electrode and the bearing part, with the electrolyte solution; and
supplying electric power to the machining electrode and the bearing part, the electric power composed of machining voltage, machining current and total supplying time; and
each regulation process including the steps of:
extracting one bearing part already formed with the sets of grooves, after producing a predetermined number of bearing parts in the production process;
measuring shapes of the grooves on the extracted bearing part;
comparing the shapes of the groove on the extracted bearing part with the shape of a design specification; and
changing settings on the electrochemical machining apparatus in accordance with a result of the comparison,
wherein the measuring steps uses a measuring apparatus having an axial line of the apparatus corresponding to the center line about which the bearing parts are rotating for measurement, wherein by rotation of the bearing part a measured point on the internal circumference surface of the bearing part is positioned on a measured circle, the step of measuring shapes of the grooves including the steps of:
holding the extracted bearing part in a position where the axial line of the bearing part is kept in line with the axial line of the apparatus;
generating an emitted laser beam;
controlling the emitted laser beam to be focused on and to be emitted substantially perpendicular to the internal circumference surface of the bearing part, and controlling a beam reflecting off the internal circumference surface of the bearing part to be returned on a beam path substantially corresponding to a path of the emitted laser beam;
detecting a length in a radial direction between an laser beam emitted point on the internal circumference surface of the bearing part and the axial line of the apparatus by comparing the reflected laser beam with the emitted laser beam;
rotating the bearing part about the center line at a predetermined angle to detect another length for another point on the internal circumference surface of the bearing part for measuring the outline shapes of fluid dynamic grooves on the measured circle; and
shifting the laser beam emitted point on the internal circumference surface of the bearing part to a predetermined position to measure the shape of the internal circumference surface of the bearing part on another measured circle.

8. A method according to claim 7, wherein the step of changing the settings on the electrochemical machining apparatus, includes changing the settings of at least one or any combination of machining voltage, machining current, total supplying time, a total amount of electricity corresponding to time integration of machining current, a gap between the machining electrode and the bearing part to be machined, concentration of the electrolyte solution, a flow rate of the electrolyte solution and the shape of the electrode.

9. A method according to claim 7, further comprising the step of supplying the electric power by a predetermined number of voltage pulses depending on the design specification, each voltage pulse having a predetermined voltage and on-duration time, and in the changing settings step of the regulation process, further comprising the step of increasing or decreasing the number of the voltage pulses depending on the result of the comparison.

10. A method of producing fluid dynamic bearing parts by means of an electrochemical machining apparatus having one or more settings to control machining, the method comprising the steps of production processes and regulation processes, each production process includes the steps of:
holding a machining electrode having a shape corresponding to a set of grooves to be machined;
holding the bearing part to confront a machining surface of the machining electrode with a predetermined clearance;
supplying electrolyte solution to fill the predetermined clearance, between the machining electrode and the bearing part, with the electrolyte solution; and supplying electric power to the machining electrode and the bearing part, the electric power composed of machining voltage, machining current and total supplying time; and
each regulation process including the steps of:
extracting one bearing part already formed with the sets of grooves, after producing a predetermined number of bearing parts in the production process;
measuring shapes of the grooves on the extracted bearing part;
comparing the shapes of the groove on the extracted bearing part with the shape of a design specification; and
changing settings on the electrochemical machining apparatus in accordance with a result of the comparison,
wherein the step of measuring shapes of the grooves including the steps of:
holding the extracted bearing part to maintain a predetermined position;
emitting an optical beam on a groove formed on the extracted bearing part to be measured;
receiving the reflected optical beam reflecting off a surface of the groove on a reflected point;
detecting a length of a beam path between the reflected point on the surface of the groove and a predetermined point of the extracted bearing part; and
shifting the reflected point to a predetermined position on the extracted bearing part.

11. A method according to claim 10, wherein the step of changing the settings on the electrochemical machining apparatus, includes changing the settings of at least one or any combination of machining voltage, machining current, total supplying time, a total amount of electricity corresponding to time integration of machining current, a gap between the machining electrode and the bearing part to be machined, concentration of the electrolyte solution, a flow rate of the electrolyte solution and the shape of the electrode.

12. A method according to claim 10, further comprising the step of supplying the electric power by a predetermined number of voltage pulses depending on the design specification, each voltage pulse having a predetermined voltage and on-duration time, and in the changing settings step of the regulation process, further comprising the step of increasing or decreasing the number of the voltage pulses depending on the result of the comparison.

13. A method for measuring outline shapes of fluid dynamic grooves formed on an internal circumference surface of a cylindrical part which has an axial line as a center line, the method comprising the steps of:
holding the cylindrical part in a position where the axial center line is kept in line with a part of a beam path of an emitted optical beam;
generating the emitted optical beam to measure outline shapes of the fluid dynamic bearing grooves;
controlling the emitted optical beam to be focused on and to be emitted substantially perpendicular to the internal circumference surface of the cylindrical part, and controlling a reflected beam off the internal circumference surface of the cylindrical part to be returned on a beam path substantially corresponding to a path of the emitted optical beam;
detecting a length in a radial direction between an optical beam emitted point on the internal circumference surface of the cylindrical part and the axial center line by comparing the emitted optical beam and the reflected optical beam; and
shifting the optical beam emitted point on the internal circumference surface of the cylindrical part to a predetermined position to measure another point on the internal circumference surface of the cylindrical part.

14. A method for measuring outline shapes of fluid dynamic grooves formed on an internal circumference surface of a cylindrical part which has a part axial line as a center line, by using an measuring apparatus having an apparatus axial line corresponding to the center line about which the cylindrical parts are rotated for measurement, the method comprising the steps of:
holding the cylindrical part in a position where the part axial line is maintained in line with the apparatus axial line;
generating an emitted laser beam;
controlling the emitted laser beam to be focused on and to be emitted substantially perpendicular to the internal circumference surface of the cylindrical part, and controlling a reflected beam off the internal circumference surface of the cylindrical part to be returned on a beam path substantially corresponding to a path of the emitted laser beam;
detecting a length in a radial direction between an laser beam emitted point on the internal circumference surface of the cylindrical part and the apparatus axial line by comparing the emitted laser beam and the reflected laser beam; and
shifting the laser beam emitted point on the internal circumference surface of the cylindrical part to a predetermined position to measure another point on the internal circumference surface of the cylindrical part.

15. A method for measuring outline shapes of fluid dynamic grooves formed on an internal circumference surface of a cylindrical part which has an axial line of the cylindrical part as a center line, by using an measuring apparatus having an axial line of the apparatus corresponding to the center line about which the cylindrical parts are rotated for measurement, wherein by rotation of the cylindrical part a measured point on the internal circumference surface of the cylindrical part is positioned on a measured circle, the method comprising the steps of:
holding the cylindrical part at a position where the axial line of the cylindrical part is maintained in line with the axial line of the apparatus;
generating an emitted laser beam;
controlling the emitted laser beam to be focused on and to be emitted substantially perpendicular to the internal circumference surface of the cylindrical part, and controlling a reflected beam off the internal circumference surface of the cylindrical part to be returned on a beam path substantially corresponding to a path of the emitted laser beam;
detecting a length in a radial direction between an laser beam emitted point on the internal circumference surface of the cylindrical part and the axial line of the apparatus by comparing the emitted laser beam and the reflected laser beam;
rotating the cylindrical part about the center line at a predetermined angle to detect another length of another point on the internal circumference surface of the cylindrical part for measuring outline shapes of fluid dynamic grooves on the measured circle; and
shifting the laser beam emitted point on the internal circumference surface of the cylindrical part to a predetermined position to measure the shape of the internal circumference surface of the cylindrical part on another measured circle.
